(19) United States
(12) Patent Application Publication
(10) Pub. No.: US 2004/0116540 A1
(43) Pub. Date: Jun. 17, 2004

(54) Impregnating agent

(76) Inventors: Volker Schlicht, Berlin (DE); Petra Koelsch, Berlin (DE)

Correspondence Address: D Ewards Dolgorukov, Marshall & Melhorn, 8th Floor, Four Seagate, Toledo, OH, 43604, US

(21) Appl. No.: 10/466,783

(22) PCT Filed: Jan. 21, 2002
(86) PCT No.: PCT/EP02/00561

(30) Foreign Application Priority Data
Jan. 19, 2001 (DE) 101 04 394.5

(51) Int. Cl. B01F 17/00

(52) U.S. Cl. 516/21

(57) ABSTRACT

The invention relates to a novel impregnating agent for leather, textiles and synthetic materials, containing at least one impregnating active ingredient incorporated into a dispersing system. At least one impregnating active ingredient is contained in the dispersing agent of a water-in-oil emulsion which forms the impregnating agent. Said impregnating agent can be produced with a desired viscosity without the need for a thickening agent to be used. Preferably, an oil-soluble emulsifier is used, containing additional impregnating qualities.

The invention relates to an impregnating agent according to the preamble of claim 1.

Impregnating agents contain the impregnating active ingredients normally in a dissolved form or in a form emulsified/dispersed in water (oil-in-water emulsion). Mainly organic liquids, such as heptane isomers, benzenes or isopropanol, serve as solvent.

Impregnating agents of this type containing solvents can however be risky because of their health-endangering effects, in particular when they are sprayed onto a surface to be treated (toxicological inhalation risk due to spray mists). They should therefore not be applied in closed rooms.

When impregnating agents of this type are applied mechanically, for example by means of a sponge onto smooth leather surfaces, the solvent can cause damage to the finish which leads to a blotchy and hence unsightly appearance.

A liquid impregnating and care product for leather, artificial leather materials and textiles with an impregnating active ingredient on fluorocarbon resins, fluorosilicones and/or organic metal compounds is known from EP 0 527 496 A1, which contains a volatile silicone as solvent or dispersing agent. Damage to the finish should not occur in the case of the latter. It is however disadvantageous here that the evaporation of the silicone can take a fairly long time and that the production of the agent is relatively costly.

The disadvantage of a water-based emulsion (oil-in-water emulsion) is the necessary use of water-soluble emulsifiers. Since these substances remain on the treated surface, they counteract the desired impregnation due to their hydrophilicity. In addition, thickening agents are required for this emulsion if it is intended to have a cream- or gel-like consistency. These thickening agents also form residues on the treated surface, as a result of which these become unsightly and, particularly when treating suede leather, conglutination of the fibres can occur, which leads to additional staining.

It is therefore the object of the present invention to indicate an impregnating agent for leather, textiles and synthetic materials, containing at least one impregnating active ingredient which is incorporated in a dispersed system which can be applied mechanically and thereby is distributed uniformly, leaves no residues on the treated surface apart from the desired active ingredients and is at least extensively solvent-free.

This object is achieved according to the invention by an impregnating agent with the features of claim 1. Advantageous developments of the impregnating agent according to the invention are revealed in the sub-claims.

As a result of the fact that at least one impregnating active ingredient is contained in the dispersing agent of the water-in-oil emulsion which forms the impregnating agent, i.e. that water represents the internal phase of the emulsion, the viscosity of the emulsion can be determined solely by the size of the water proportion; the greater the water proportion is, the more viscose is the emulsion. This can hence obtain a cream- or gel-like consistency without using any thickening agents. It is noteworthy that the water proportion of the emulsion can be up to 95% by weight, whilst normally the proportion of the external phase in an emulsion is greater than the proportion of the internal phase.

Preferably, the impregnating agent contains an oil-soluble emulsifier which itself already has hydrophobing properties and hence increases the impregnating effect. Silicone emulsifiers, of which in particular polyether polydimethyl siloxane copolymers should be mentioned, have proved to be particularly suitable.

Suitable impregnating active ingredients are fluorocarbon polymers (fluorocarbon resins) which have such a high surface tension that they have not only water-repellant properties but also oil-repellant properties. A further advantageous impregnating active ingredient is aminofunctional siloxane which likewise is highly water-repellant and in addition improves the polishing ability on smooth leather (polydimethyl siloxanes have proved here to be particularly expedient). Aminofunctional siloxanes of this type are reactive substances which can have a health-damaging effect. They are therefore unsuitable for a spray application but can be used safely for application with a sponge, a cloth or a brush.

In addition, fats and/or oils can increase the suppleness and softness of the treated surface and hence improve the surface texture.

A general formulation for an embodiment of an impregnating agent according to the present invention can have the following composition (values in % by weight):

| | | | |
|---|---|---|---|
| wool grease (lanolin) | 0.01-5% | preferably | 0.1-3% |
| n-iso/cyclic aliphates | 0.5-20% | preferably | 2-6% |
| (white spirit) | | | |
| silicone emulsifier | 0.5-10% | preferably | 0.5-4% |
| paraffin oil | 0.1-10% | preferably | 0.1-3% |
| polydimethyl siloxanes | 0.1-10% | preferably | 0.5-4% |
| (aminofunctional) | | | |
| plant oils | 0.1-5% | preferably | 0.1-2% |
| fluoroalkyl copolymers | 0.1-10% | preferably | 1-5% |
| scents, colourants | 0-2% | preferably | 0.1-0.5% |
| water (demineralised) | 30-95% | preferably | 70-95% |

The aminofunctional polydimethyl siloxanes and the fluoroalkyl copolymers here are primarily impregnating active ingredients and the wool grease, the paraffin oil and also the plant oils serve primarily as care products. The silicone emulsifier gives the emulsion the required stability and has in addition the property of an impregnating active ingredient. The white spirit is used as solvent for the oil-soluble components.

The production of this impregnating agent can be effected in such a manner that firstly the wool grease is dissolved in the white spirit at a temperature of approximately 50° C. Subsequently, the oil-soluble components (all components apart from the water) are added and agitated homogeneously. Finally the mixture is mixed slowly with water with intensive agitation, a water-in-oil emulsion being formed. The addition of water is effected until the desired viscosity is achieved (an increase in the water proportion increases the viscosity).

The thus obtained impregnating agent is applied according to specification with a sponge or cloth onto the surface to be treated. After sufficient drying time, smooth leathers are polished, suede leathers are roughened and textiles are brushed. The application can be repeated many times without a negative change in the appearance of the material surface occurring. Rather, smooth and suede leathers become more intensively coloured.

The impregnating tests which were implemented produced the following results:

1. Water drop test (after 3 m): observation time 10 s; the drawing-in of the drop into the material was assessed

| Type of material | Untreated | Treated with impregnating gel |
|---|---|---|
| Smooth leather (coated) | 10 | 10 |
| Nubuck leather | 1 | 10 |
| Suede leather | 1 | 10 |
| Calf leather | 7 | 10 |
| Textile (cotton) | <W | 8 |

2. Oil-repellant test according to AATCC 118

| Type of material | Untreated | Treated with impregnating gel |
|---|---|---|
| Smooth leather (coated) | 6 | 8 |
| Nubuck leather | 2 | 4 |
| Suede leather | 2 | 3 |
| Calf leather | 3 | 5 |
| Textile (cotton) | <1 | 4 |

1. Impregnating agent for leather, textiles and synthetic materials, containing at least one impregnating active ingredient which is incorporated in a dispersed system,
characterised in that
at least one impregnating active ingredient is contained in the dispersing agent of a water-in-oil emulsion which forms the impregnating agent, having a water proportion of 30-95 percent by weight.

2. Impregnating agent according to claim 1, characterised in that it has aminofunctional siloxanes and/or fluorocarbon polymers as impregnating active ingredients.

3. Impregnating agent according to claim 2, characterised in that the siloxane is a polydimethyl siloxane.

4. Impregnating agent according to claim 2, characterised in that the fluorocarbon polymer is a fluoroalkyl copolymer.

5. Impregnating agent according to claim 1, characterised in that it contains an oil-soluble emulsifier.

6. Impregnating agent according to claim 5, characterised in that the emulsifier is a silicone emulsifier.

7. Impregnating agent according to claim 6, characterised in that the silicone emulsifier is a polyether-polydimethyl siloxane copolymer.

8. Impregnating agent according to claim 1, characterised in that it contains in addition care active ingredients.

9. Impregnating agent according to claim 8, characterised in that it contains wool grease (lanolin) and/or paraffin oil and/or plant oils as care active ingredients.

10. Impregnating agent according to claim 1, characterised in that it contains oil-soluble scents and/or colourants.

11. Impregnating agent according to claim 1, characterised in that it contains n-iso/cyclic aliphates (white spirit) as solvent for the oil-soluble components.

12. Impregnating agent according to claim 1, characterised in that the proportion of water is 70-95 percent by weight.

13. Impregnating agent according to claim 3, characterised in that it contains aminofunctional dimethyl polysiloxanes with a proportion of 0.1-10 percent by weight.

14. Impregnating agent according to claim 13, characterised in that the proportion of dimethyl polysiloxanes is 0.5-4 percent by weight.

15. Impregnating agent according to claim 4, characterised in that it contains fluorocarbon polymers with a proportion of 0.1-10 percent by weight.

16. Impregnating agent according to claim 15, characterised in that the proportion of fluorocarbon polymers is 1-5 percent by weight.

17. Impregnating agent according to claim 6, characterised in that it contains a silicone emulsifier with a proportion of 0.5-10 percent by weight.

18. Impregnating agent according to claim 17, characterised in that the proportion of silicone emulsifier is 0.5-4 percent by weight.

19. Impregnating agent according to claim 9, characterised in that it contains wool grease with a proportion of 0.01-5 percent by weight.

20. Impregnating agent according to claim 9, characterised in that it contains paraffin oil with a proportion of 0.1-10 percent by weight.

21. Impregnating agent according to claim 9, characterised in that it contains plant oils with a proportion of 0.1-5 percent by weight.

22. Impregnating agent according to claim 10, characterised in that it contains scents and/or colourants with a proportion of 0-2 percent by weight.

23. Impregnating agent according to claims 11, characterised in that it contains n-iso/cyclic aliphates with a proportion of 0.5-20 percent by weight.
